(19) United States
(12) Patent Application Publication
(10) Pub. No.: US 2025/0229409 A1
(43) Pub. Date: Jul. 17, 2025

(54) ROTARY TRANSLATIONAL POSITIONER WITH MULTIPLE DEGREES OF FREEDOM

(71) Applicants: Tianjin University, Tianjin (CN); Tianjin Shangde New Technology Co, Ltd., Tianjin (CN); BCEG Civil Engineering Co, LTD., Beijing (CN)

(72) Inventors: Lianyong XU, Tianjin (CN); Kangda HAO, Tianjin (CN); Hao WANG, Tianjin (CN); Yongdian HAN, Tianjin (CN); Lei ZHAO, Tianjin (CN); Wenjing REN, Tianjin (CN); Tianzhu WANG, Tianjin (CN)

(73) Assignees: Tianjin University, Tianjin (CN); Tianjin Shangde New Technology Co., Ltd., Tianjin (CN); BCEG CIVIL ENGINEERING CO., LTD., Beijing (CN)

(21) Appl. No.: 18/961,514

(22) Filed: Nov. 27, 2024

(30) Foreign Application Priority Data
Jan. 12, 2024 (CN) 202410048145.2

(51) Int. Cl. B25H 1/10

(52) U.S. Cl. CPC B25H 1/10

(57) ABSTRACT

A rotary translational positioner with multiple degrees of freedom includes support frames, a main rotary dynamic structure, a main frame, an auxiliary dynamic structure, an auxiliary frame, and a worktable, where the main frame is arranged between the support frames, the main rotary dynamic structure is arranged at the end of the main frame and is located between the main frame and the support frame, the auxiliary frame is arranged in the main frame through the auxiliary dynamic structure, the auxiliary dynamic structure is arranged at the front end and the rear end of the auxiliary frame, and the worktable is arranged on the auxiliary frame. A main and auxiliary double frame structure is adopted, the main frame can adjust the position and angle of the whole welding workpiece, and the auxiliary frame can adjust the position and angle of the welding parts.

### CROSS REFERENCE TO THE RELATED APPLICATIONS

This application is based upon and claims priority to Chinese Patent Application No. 202410048145.2, filed on Jan. 12, 2024, the entire contents of which are incorporated herein by reference.

### TECHNICAL FIELD

The invention relates to the technical field of positioners, in particular to a rotary translational positioner with multiple degrees of freedom.

### BACKGROUND

As a common fixture in the welding production line, the positioner realizes the fixation of parts in the welding operation, the existing common positioner only has the function of single-axis rotation, in the welding operation, the parts are rotated around the shaft to meet the requirements of the welding angle, which can effectively improve the efficiency and quality of the welding operation. However, with the development of welding automation and intelligence, the one-degree-of-freedom positioner with single-axis rotation cannot meet the requirements of welding operations, and with the increase in the complexity of the structure of the welded workpiece, to ensure the welding quality of the workpiece or improve the efficiency of the operation, it is necessary to perform the welding of multiple parts at the same time, and the welding positions and angles of multiple parts may be different, moreover, with the progress of welding operations, it is not only necessary to transform the position angle of the entire workpiece, but also to transform the position angle of the internal parts of the workpiece to meet the requirements of multi-point welding operations inside and outside the workpiece. The existing positioners have defects of insufficient applicability and flexibility, which are no longer applicable to the existing welding operation and cannot meet the needs of the existing welding operation. The invention provides a rotary translational positioner with multiple degrees of freedom to solve the above problems.

### SUMMARY

The invention provides a rotary translational positioner with multiple degrees of freedom, which adopts a double frame structure and multiple degrees of freedom action to meet the requirements of complex welding operations.

The technical scheme adopted by the invention to solve the above technical problems is as follows:

A rotary translational positioner with multiple degrees of freedom, including support frames, a main rotary dynamic structure, a main frame, an auxiliary dynamic structure, an auxiliary frame, and a worktable, the main frame is located between the support frames, the main rotary dynamic structure is set at an end of the main frame and located between the main frame and the support frames, the auxiliary frame is located in the main frame through the auxiliary dynamic structure, the auxiliary dynamic structure is located at a front end and a rear end of the auxiliary frame, and the worktable is located on the auxiliary frame;
the auxiliary dynamic structure includes an auxiliary rotary dynamic device and a displacement device, the displacement device is arranged inside the main frame, the auxiliary rotary dynamic device is arranged at an end of the auxiliary frame to drive the auxiliary frame to rotate, the displacement device is connected with the auxiliary rotary dynamic device to drive the auxiliary rotary dynamic device to move.

Furthermore, the displacement device includes a displacement guide rail, a sliding table, and a translational dynamic device, the displacement guide rail is arranged on an inner side of the main frame, the sliding table is movably arranged on the displacement guide rail and connected with the auxiliary rotary dynamic device, and the translational dynamic device is connected with the sliding table.

Furthermore, the auxiliary frame is set in pairs, and an output end of the translational dynamic device is provided with a displacement rod, and the sliding table at the same end of the two auxiliary frames is connected to the same displacement rod, the displacement rod is provided with threads in an opposite direction, and the two sliding tables are respectively arranged on thread sections in different directions.

Furthermore, the auxiliary rotary dynamic device includes an auxiliary rotary positioner, an auxiliary rotary shaft, and a rotary table, the auxiliary rotary positioner and the auxiliary rotary shaft are arranged on the sliding table and located at both ends of the auxiliary frame, the rotary table is connected to the auxiliary frame through a hinge and is connected to the auxiliary rotary positioner and the auxiliary rotary shaft.

Furthermore, the main rotary dynamic structure includes a main rotary positioner and a main rotary shaft, the main rotary positioner and the main rotary shaft are respectively arranged outside the two ends of the main frame to drive the main frame to rotate.

Furthermore, torque sensors are arranged on both the main rotary positioner and the auxiliary rotary positioner, and a torque balance block is arranged on both the main rotary positioner and the auxiliary rotary positioner.

Furthermore, the main rotary positioner and the auxiliary rotary positioner are equipped with a two-stage reducer.

Furthermore, the translational dynamic devices are set to 2-4.

Furthermore, the worktable is a multilateral special-shaped structure, the main frame is a rectangular box, and the auxiliary frame is a rectangular frame.

Furthermore, a dimension positioning beacon is arranged on the worktable.

The beneficial effects of the invention are as follows:

The main frame can adjust the position and angle of the whole welding workpiece, and the auxiliary frame can adjust the position and angle of the welding parts to meet the welding operation requirements of the complex special-shaped workpiece, the main and auxiliary frames are equipped with dynamic structures to realize the flexible adjustment of the main and auxiliary frames, so that the whole device has multiple degrees of freedom to meet the needs of complex welding operations.

The position and angle adjustment of multi-degree-of-freedom can meet the simultaneous adjustment of welded workpieces and parts, meet the requirements of multi-point welding, and thus improve welding efficiency and quality.

### BRIEF DESCRIPTION OF THE DRAWINGS

FIG. 1 is an overall structure diagram of the invention;

FIG. 2 is a schematic diagram of the overall structure of the invention;

FIG. 3 is a schematic diagram of the overall structure of the invention;

FIG. 4 is a schematic diagram of the connection between the auxiliary frame and the main frame of the invention;

FIG. 5 is a schematic diagram of the connection between the auxiliary frame and the auxiliary dynamic structure of the invention;

FIG. 6 is a schematic diagram of the auxiliary dynamic structure of the invention;

FIG. 7 is a schematic diagram of the connection between the auxiliary rotary dynamic device and the positioning device of the invention;

FIG. 8 is a schematic diagram of the auxiliary frame posture I of the invention;

FIG. 9 is a schematic diagram of the auxiliary frame posture II of the invention;

FIG. 10 is a schematic diagram of the auxiliary frame posture III of the invention;

FIG. 11 is a schematic diagram of the auxiliary frame posture IV of the invention;

Marks in the figures: 1—support frame, 2—main rotary dynamic structure, 3—main frame, 4—auxiliary dynamic structure, 41—auxiliary rotary dynamic device, 42—displacement device, 5—auxiliary frame, 6—worktable.

### DETAILED DESCRIPTION OF THE EMBODIMENTS

The technical scheme of the embodiment of the invention is clearly and completely described in combination with the drawings attached to the instructions. Obviously, the embodiment described is only a part of the embodiment of the invention, not the whole embodiment. Based on the embodiments in this invention, all other embodiments obtained by ordinary technicians in this field without making creative labor belong to the scope of protection of this invention.

In the description of the invention, it is necessary to understand that the orientation or positional relationship indicated by the terms center, up, down, front, back, left, right, vertical, horizontal, top, bottom, inside, outside is based on the orientation or positional relationship shown in the attached figures, only to facilitate the description of the invention and simplify the description, rather than indicating or implying that the device or component referred to must have a specific orientation, be constructed and operated in a specific orientation, it cannot be understood as a restriction on the invention.

With the increase of the structural complexity of the workpiece and the shape complexity of the special-shaped components, such as the cage structure of the workpiece and the complex structure of the U-shaped and Z-shaped parts, there will be welding requirements at different positions and angles in the three-dimensional space. However, the existing rotating positioner around the shaft cannot meet the above requirements, and it is necessary to weld one by one. In the welding process, frequent disassembly and assembly of the workpiece and check of the position are required, which greatly affects the operation efficiency, and because some parts need to be welded at the same time to avoid the structural deformation defects in the successive welding of the parts, in order to ensure the welding efficiency and welding quality. The positioner needs to meet the construction technology of multi-point welding at the same time, the multi-degree-of-freedom positioner of the invention can realize multi-point simultaneous welding in three-dimensional space and meet the requirements of the welding process.

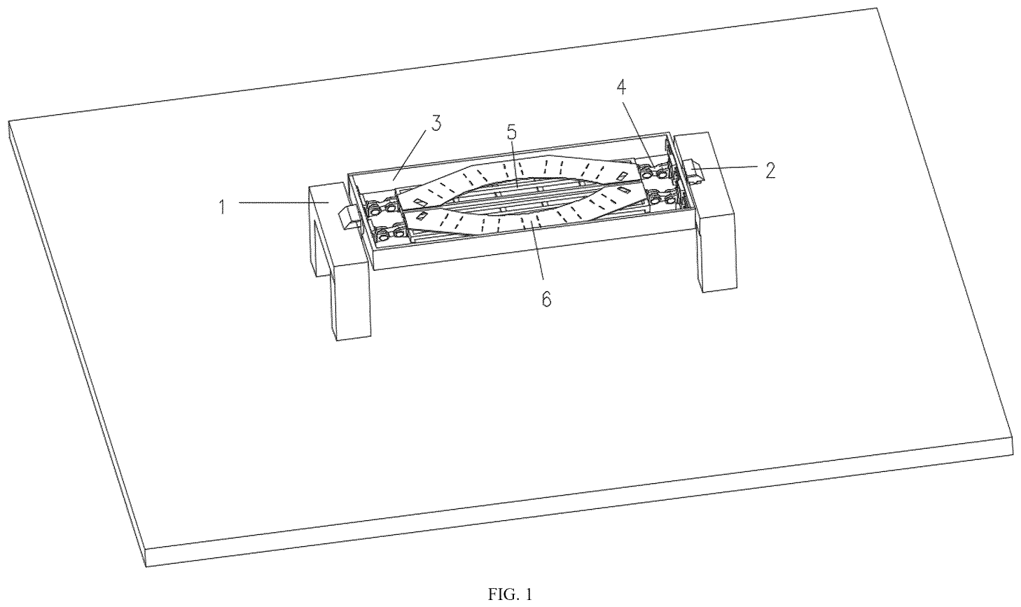

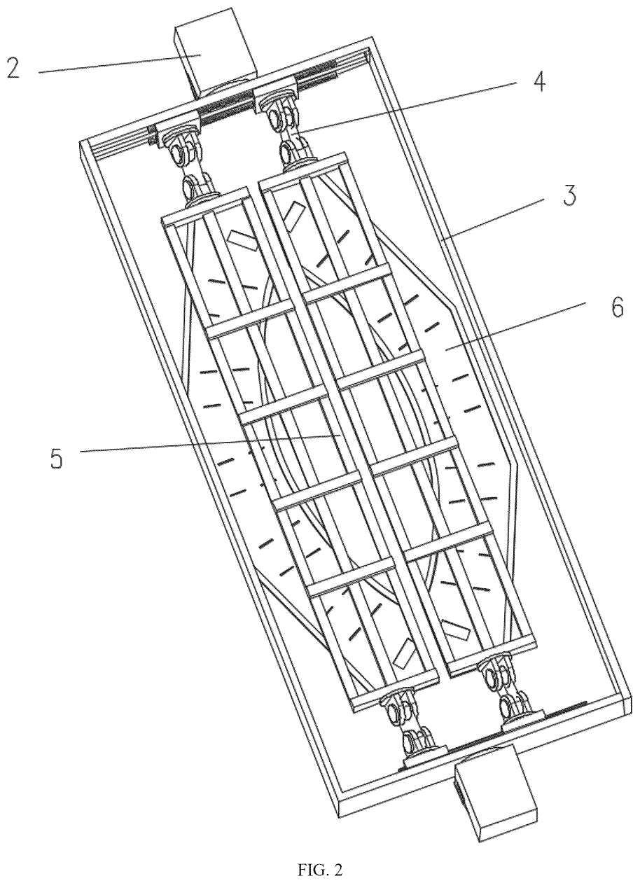

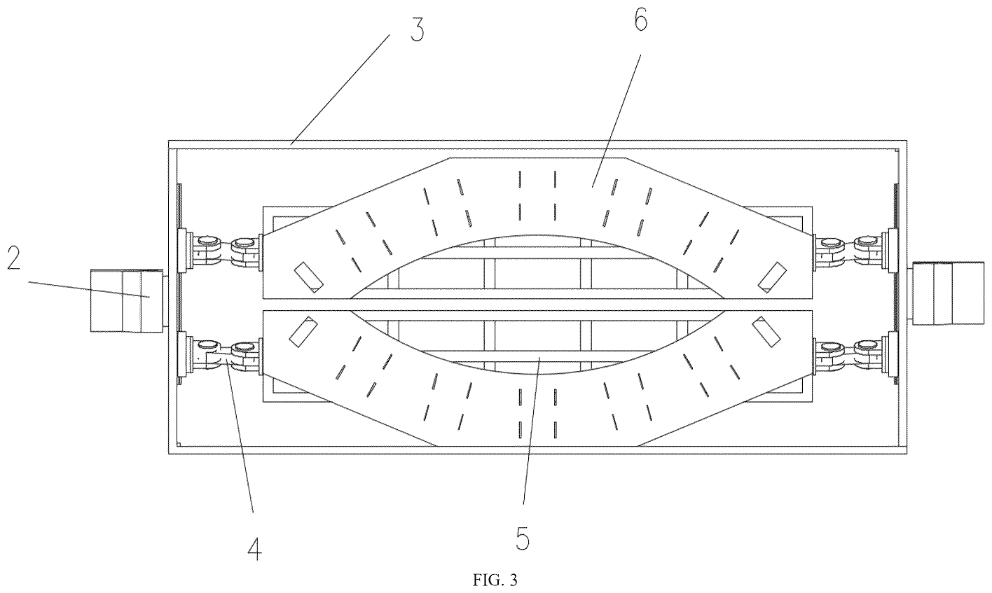

As shown in FIGS. 1-3, a rotary translational positioner with multiple degrees of freedom includes support frames 1, a main rotary dynamic structure 2, a main frame 3, an auxiliary dynamic structure 4, an auxiliary frame 5, and a worktable 6, the main frame 3 is located between the support frames 1, the main rotary dynamic structure 2 is located at the end of the main frame 3 and is located between the main frame 3 and the support frame 1, the auxiliary frame 5 is located in the main frame 3 through the auxiliary dynamic structure 4, the auxiliary dynamic structure 4 is located at the front end and rear end of the auxiliary frame 5, and the worktable 6 is located on the auxiliary frame 5.

The specific embodiment of the invention realizes the position and angle adjustment of the whole workpiece by driving the main frame 3 through the main rotary dynamic structure 2, the main rotary dynamic structure 2 is set at both ends of the main frame 3, and the main frame 3 is driven by the main rotary positioner to rotate around the shaft, so that the main frame 3 and the workpiece on it rotate, and then cooperate with the welding operation of the welding robot, the main frame 3 is a rectangular frame, and two auxiliary frames 5 are set in the main frame 3, the two auxiliary frames 5 are driven by the auxiliary dynamic structure 4 to realize the operation of rotation, translation, closure or expansion, and meet the welding operation of parts at different positions and angles, the auxiliary rotary dynamic device 41 is located at the end of the auxiliary frame 5, which drives the auxiliary frame 5 to rotate around the axis, the displacement device 42 is located outside the auxiliary rotary dynamic device 41, which drives the auxiliary rotary dynamic device 41 and the auxiliary frame 5 to move, the displacement device 42 at both ends of the two auxiliary frames 5 is flexibly adjusted under different action modes, so that the two auxiliary frames 5 are in different positions, the flexible adjustment of the position and angle of the parts in the three-dimensional space are meet, the requirements of multi-point welding of parts and angle adjustment of the whole workpiece are realized through the above structure.

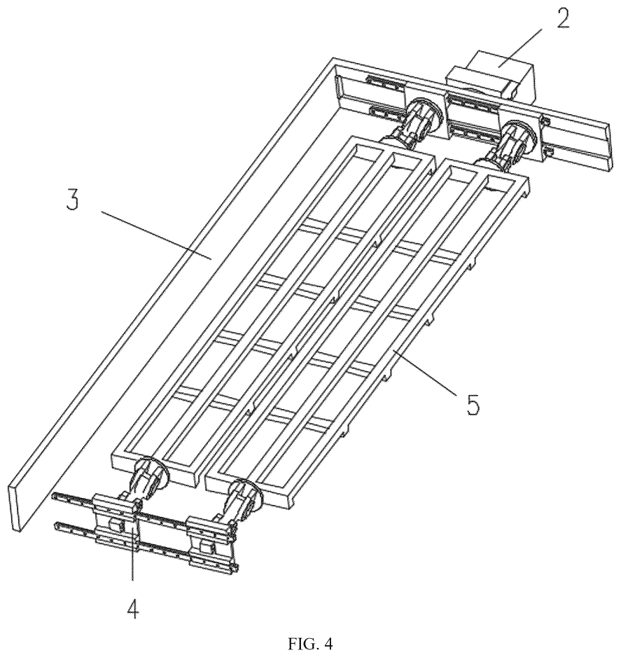

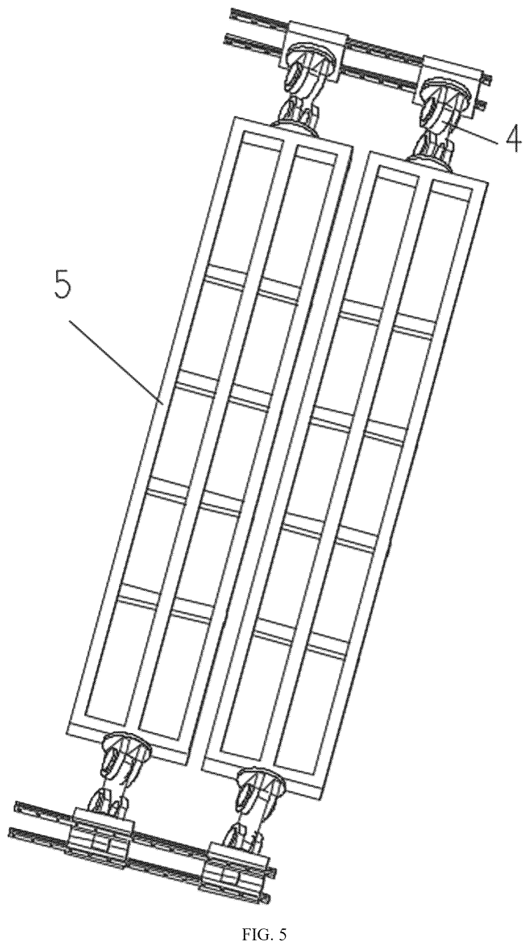

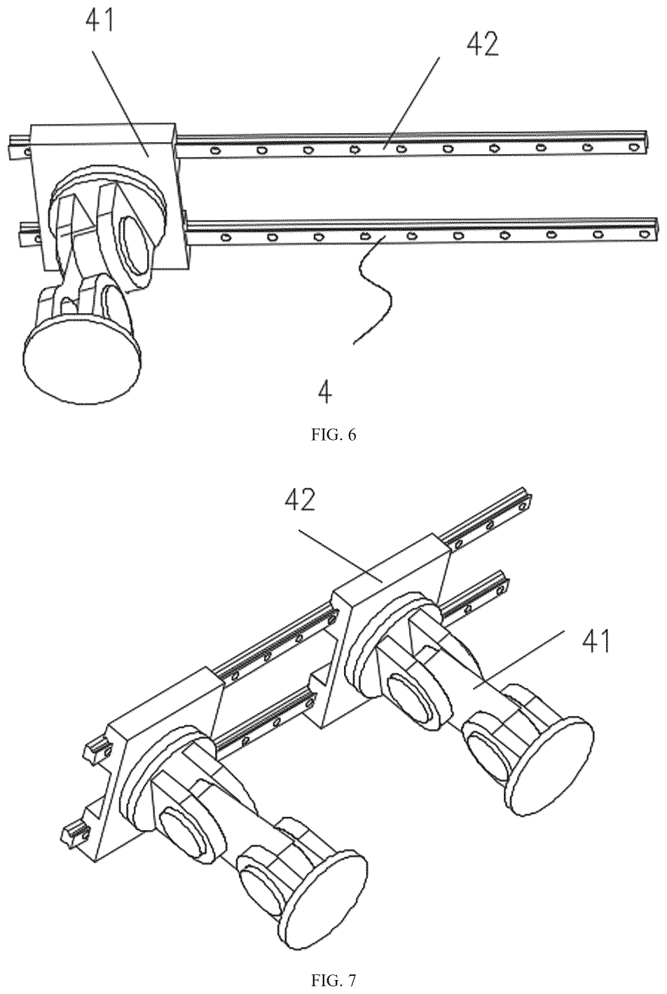

As shown in FIGS. 4-7, the auxiliary dynamic structure 4 includes the auxiliary rotary dynamic device 41 and the displacement device 42, the displacement device 42 is located inside the main frame 3, which drives the auxiliary rotary dynamic device 41 and the auxiliary frame 5 to act, the auxiliary rotary dynamic device 41 is located at the end of the auxiliary frame 5, which drives the auxiliary frame 5 to rotate, the displacement device 42 is connected to the auxiliary rotary dynamic device 41, which drives the auxiliary rotary dynamic device 41 to translate.

Furthermore, the displacement device 42 includes a displacement guide rail, a sliding table, and a translational dynamic device, the displacement guide rail is arranged on the inner side of the main frame 3, and the sliding table is arranged on the displacement guide rail and connected with the auxiliary rotary dynamic device 41, the translational dynamic device is connected to the sliding table.

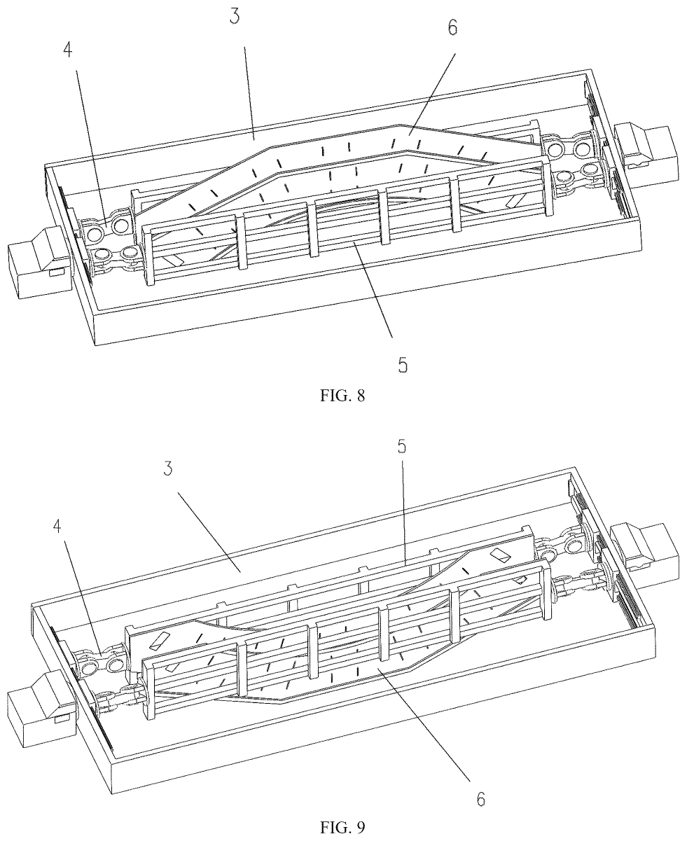

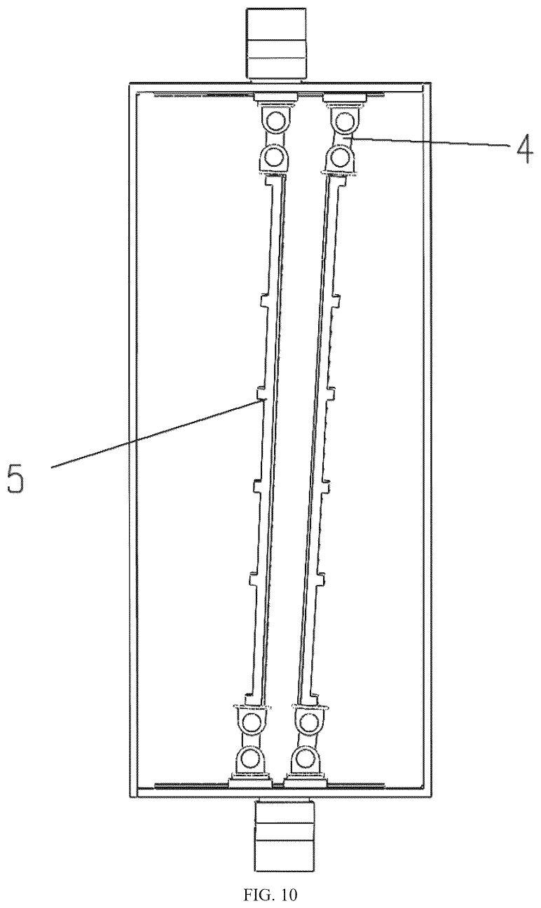

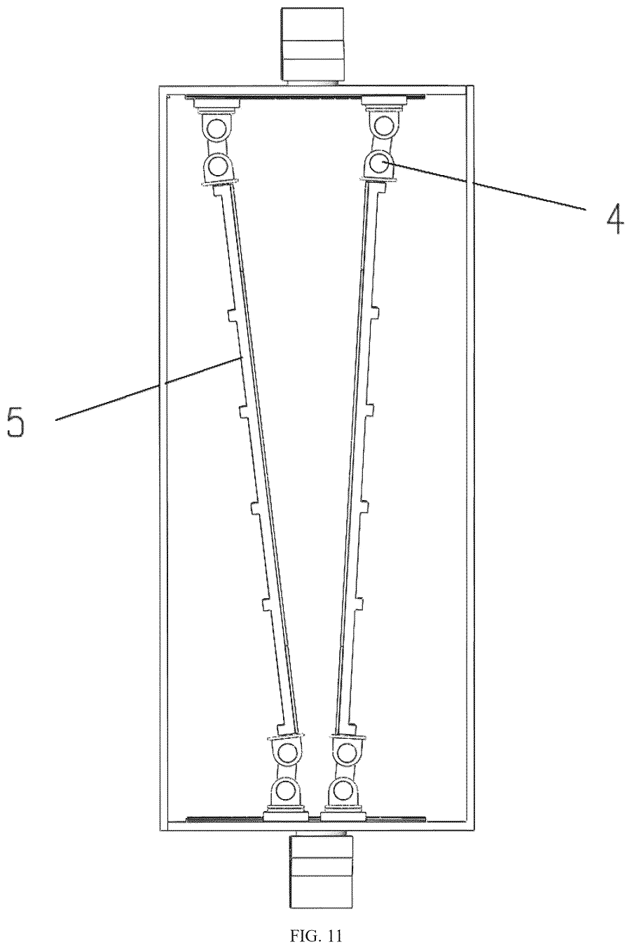

As shown in FIGS. 8-11, the auxiliary frames 5 are set in pairs, a total of two, and different numbers of the auxiliary frame 5 can be set according to the welding construction requirements, at the same time, according to the complexity of the workpiece, different numbers of displacement devices 42 are used to make the whole device have different degrees of freedom; when a displacement device 42 is set at both ends of the two auxiliary frames 5, the same ends of the two auxiliary frames 5 are connected to the same displacement bar at the same time, the displacement device 42 is connected to the displacement bar, and one displacement bar and one displacement device 42 are set, at this time, it is a five-degree-of-freedom mode, that is, a main rotary dynamic structure 2 is connected to the main frame 3, two sub-rotary dynamic devices 41 are connected to the two auxiliary frames 5, and two displacement devices 42 are connected to the two ends of the auxiliary frame 5 set in a pair; when the displacement device 42 is set at both ends of each auxiliary frame 5, it is a seven-degree-of-freedom mode, that is, a main rotary dynamic structure 2 is connected to the main frame 3, two auxiliary rotary dynamic devices 41 are respectively connected to two auxiliary frames 5, two displacement devices 42 are respectively connected to both ends of each auxiliary frame 5, a total of four displacement devices 42; when one end of the two auxiliary frames 5 is independently connected to the displacement device 42, and the other end of the two auxiliary frames 5 is simultaneously connected to the same displacement rod, the displacement rod is connected to the displacement device 42, it is a six-degree-of-freedom mode.

The adjustment of parts by seven-degree-of-freedom is more flexible and can better meet the needs of welding position, but the cost is higher, and the seven-degree-of-freedom mode is adopted when the workpiece with asymmetry and high specificity is welded, five-degree-of-freedom can meet the welding requirements of symmetrical workpieces, and the cost is relatively low, the five-degree-of-freedom mode is adopted when welding symmetrical and regular components of the structure; the six-degree-of-freedom mode is rarely adopted because it can not effectively meet the specific requirements, and the cost control is also poor.

Furthermore, in the seven-degree-of-freedom mode of this embodiment, the auxiliary rotary dynamic device 41 is located at both ends of the auxiliary frame 5, and two displacement devices 42 are respectively connected with the auxiliary rotary translational positioner and the auxiliary rotary shaft of the auxiliary rotary dynamic device 41, each displacement device 42 independently drives one end of the auxiliary frame 5 to move, while the auxiliary rotary dynamic device 41 located between the two displacement devices 42 drives the auxiliary frame 5 to rotate around the shaft, and cooperates with the translation realized by the displacement device 42 to adjust the position and angle of the auxiliary frame 5.

Furthermore, in the five-degree-of-freedom mode of this embodiment, a displacement rod is arranged on the output end of the translational dynamic device, and two sliding tables at the same end of the auxiliary frame 5 are connected to the same displacement rod, the displacement rod is equipped with threads in opposite directions, the two sliding tables are respectively arranged on the thread sections in different directions, the screw nut structure is between the sliding table and the displacement rod, the translational dynamic device drives the displacement rod to rotate, and the two sliding tables are driven by the displacement rod to move in opposite directions, the displacement device 42 drives the same end of the two auxiliary frames 5 to close or expand in opposite directions, another displacement device 42 drives the other end of the two auxiliary frames 5 to also close or expand in opposite directions relatively independently, and adjusts the position and angle of the auxiliary frame 5.

Furthermore, the auxiliary rotary dynamic device 41 includes an auxiliary rotary positioner, an auxiliary rotary shaft, and a rotary table, the auxiliary rotary positioner and the auxiliary rotary shaft are arranged on the sliding table and are located at both ends of the auxiliary frame 5, the rotary table is connected to the auxiliary frame 5 through a hinge and is connected to the auxiliary rotary positioner and the auxiliary rotary shaft.

When adjusting the position of the auxiliary frame 5 through the displacement device 42, the length of the auxiliary frame 5 cannot meet the length requirement of the main frame 3, the auxiliary frame 5 and the auxiliary rotary dynamic device 41 are connected by hinges to compensate the distance, and the rotary action of the auxiliary rotary dynamic device 41 is not affected.

Furthermore, the main rotary dynamic structure 2 includes the main rotary positioner and the main rotary shaft, the main rotary positioner and the main rotary shaft are respectively located on the outer sides of the two ends of the main frame 3, which drives the main frame 3 to rotate.

Furthermore, the main rotary positioner and the auxiliary rotary positioner are equipped with torque sensors, the torque sensor is used to measure the deflection torque caused by the position deviation of the workpiece and parts, and the main frame 3 and the secondary frame 5 are equipped with torque balance blocks, the torque balance block reduces the deflection torque so that the main rotary positioner and the auxiliary rotary positioner can be flipped and started.

Furthermore, a secondary reducer is arranged on both the main rotary positioner and the auxiliary rotary positioner to meet the requirements of offset and bearing capacity.

Furthermore, the translational dynamic devices are set to 2-4, it is a five-degree-of-freedom mode when there are two translational dynamic devices, it is a six-degree-of-freedom mode when there are three translational dynamic devices, it is a seven-degree-of-freedom mode when there are four translational dynamic devices.

Furthermore, the worktable 6 is a multilateral special-shaped structure, that cooperates with the welding robot to improve the accessibility of the robot, the main frame 3 is a rectangular box, and the auxiliary frame 5 is a rectangular frame.

Furthermore, the worktable 6 is equipped with a latitude and longitude dimension positioning beacon, which is convenient for automatic positioning and locating during welding.

Furthermore, the support frame 1 includes a head frame and a tail frame, the main rotary positioner is arranged on the head frame, and the main rotary shaft is arranged on the tail frame.

For technicians in this field, it is obvious that the invention is not limited to the details of the above embodiments, and can be realized in other specific forms without deviating from the spirit or basic characteristics of the invention. Therefore, no matter from which point of view, the embodiment should be regarded as exemplary and non-restrictive, the scope of the invention is limited by the attached claims rather than the above description. Therefore, it aims to include all changes within the meaning and scope of the equivalent elements of the claim in the invention, and should not regard any accompanying mark in the claim as the claim involved in the restriction.

What is claimed is:

1. A rotary translational positioner with multiple degrees of freedom, comprising support frames, a main rotary dynamic structure, a main frame, an auxiliary dynamic structure, an auxiliary frame, and a worktable, wherein the main frame is located between the support frames, the main rotary dynamic structure is set at an end of the main frame and located between the main frame and the support frames, the auxiliary frames are set in the main frame in a pair through the auxiliary dynamic structure, the auxiliary dynamic structure is located at a front end and a rear end of the auxiliary frame, and the worktable is located on the auxiliary frame;
the auxiliary dynamic structure comprises an auxiliary rotary dynamic device and a displacement device, wherein the displacement device is arranged inside the main frame, the auxiliary rotary dynamic device is arranged at each of the front end and the rear end of the auxiliary frame to drive the auxiliary frame to rotate, and the displacement device is connected with the auxiliary rotary dynamic device to drive the auxiliary rotary dynamic device to move;
the displacement device comprises a displacement guide rail, a sliding table, and a translational dynamic device, wherein the displacement guide rail is arranged on an inner side of the main frame, the sliding table is movably arranged on the displacement guide rail and connected with the auxiliary rotary dynamic device, and the translational dynamic device is connected with the sliding table;
the auxiliary rotary dynamic device comprises an auxiliary rotary positioner, an auxiliary rotary shaft, and a rotary table, wherein the auxiliary rotary positioner and the auxiliary rotary shaft are arranged on the sliding table and located at both ends of the auxiliary frame, and the rotary table is connected to the auxiliary frame through a hinge and is connected to the auxiliary rotary positioner and the auxiliary rotary shaft;
the main rotary dynamic structure comprises a main rotary positioner and a main rotary shaft, wherein the main rotary positioner and the main rotary shaft are respectively arranged on an outer side of two ends of the main frame to drive the main frame to rotate; and
torque sensors are arranged on both the main rotary positioner and the auxiliary rotary positioner, and a torque balance block is arranged on both the main rotary positioner and the auxiliary rotary positioner.

2. The rotary translational positioner according to claim 1, wherein an output end of the translational dynamic device is provided with a displacement rod, two sliding tables at a same end of the auxiliary frames in the pair are connected to a same displacement rod, the displacement rod is provided with threads in an opposite direction, and the two sliding tables are respectively arranged on thread sections in different directions.

3. The rotary translational positioner according to claim 1, wherein the main rotary positioner and the auxiliary rotary positioner are equipped with a two-stage reducer.

4. The rotary translational positioner according to claim 1, wherein the translational dynamic devices are set to 2-4.

5. The rotary translational positioner according to claim 1, wherein the worktable is a multilateral special-shaped structure, the main frame is a rectangular box, and the auxiliary frame is a rectangular frame.

6. The rotary translational positioner according to claim 1, wherein a dimension positioning beacon is arranged on the worktable.
